(19) United States
(12) Patent Application Publication
(10) Pub. No.: US 2009/0129697 A1
(43) Pub. Date: May 21, 2009

(54) ELECTRONIC DEVICE, DUAL VIEW DISPLAY AND THE SIGNAL COMPENSATING APPARATUS AND METHOD THEREOF

(75) Inventors: Yao Jen CHANG, Miaoil County (TW); Sheng Nan Fan, Jhudong Township (TW); I Lin Wu, Tainan City (TW)

Correspondence Address: VENABLE LLP, P.O. BOX 34385, WASHINGTON, DC, 20043-9998, US

(73) Assignee: TPO Displays Corp., Chu-Nan (TW)

(21) Appl. No.: 12/270,260

(22) Filed: Nov. 13, 2008

(30) Foreign Application Priority Data
Nov. 15, 2007 (TW) 96143315

(51) Int. Cl. G06K 9/40; G09G 5/02

(52) U.S. Cl. 382/274; 345/600

(57) ABSTRACT

The present invention relates to a signal compensating apparatus, which is used for generating a plurality of image control signals to control a plurality of sub-pixels of a display correspondingly, so that a backlight can form a left image and a right image via the plurality of sub-pixels after passing through an optical grating. The signal compensating apparatus comprises an input unit for receiving a plurality of image input signals sequentially, a compensating unit that compensates the received N-th image input signal based on the received (N+1)th image input signal to produce the N-th image control signal and an output unit for outputting the N-th image control signal to the sub-pixel corresponding to the N-th image input signal.

### BACKGROUND OF THE INVENTION

1. Field of the Invention

The present invention relates to a display and a method thereof for compensating the image control signal, more specifically a dual view display and the signal compensating method thereof.

2. Description of Related Art

A conventional dual view display uses a barrier to divide the adjacent sub-pixels into two sub-pixels, one for the left side view and the other for the right side view.

Referring to FIG. 4 that shows the display configuration of a conventional dual view display. The grating structure of the dual view display allows users on the left side to view the effects shown by sub-pixels 2, 4, 6, etc while users on the right side can view the effects shown by sub-pixels 1, 3, 5, etc. Thus a dual view display with one display screen can present different display effects at different angles.

However, since there is a coupling capacitance between adjacent sub-pixels, the voltage stored in a sub-pixel will be influenced by the next transmitted voltage, and then the brightness of the sub-pixel is affected. As a conventional dual view display adopts a barrier to divide one display screen into right and left areas, one area will contain the image information of the other because of the capacitance coupling effect and thereby produce cross-talk effect in both areas.

### SUMMARY OF THE INVENTION

The object of the present invention is to provide a dual view display which can display a plurality of images on one display screen. Moreover, it adopts a signal compensating apparatus to compensate the capacitance coupling effect between adjacent sub-pixels to prevent cross talk of the plurality of images on the display screen.

Another object of the present invention is to provide an image signal compensating method for dual view display to prevent cross talk of the dual view display screen by compensating the image input signals.

To achieve the aforesaid objects, the present invention provides a signal compensating apparatus for generating a plurality of image control signals to control a plurality of sub-pixels of a display correspondingly, so that a backlight can form a left image and a right image via the plurality of sub-pixels after passing through an optical grating. The signal compensating apparatus comprises an input unit for receiving a plurality of image input signals sequentially, a compensating unit for compensating the received N-th image input signal based on the received (N+1)th image input signal to produce the N-th image control signal, and an output unit for outputting the N-th image control signal to the sub-pixel corresponding to the N-th image input signal.

To achieve the aforesaid objects, the present invention also provides a signal compensating method for generating a plurality of image control signals to control a plurality of sub-pixels of a display correspondingly, so that a backlight can form a left image and a right image via the plurality of sub-pixels after passing through an optical grating. The signal compensating method comprises the steps of: receiving a plurality of image input signals, compensating the received N-th image input signal based on the received (N+1)th image input signal to produce the N-th image control signal and outputting the N-th image control signal to the sub-pixel corresponding to the N-th image input signal.

To achieve the aforesaid objects, the present invention further provides a dual view display having a signal compensating apparatus for generating a plurality of image control signals to control a plurality of sub-pixels of the dual view display correspondingly, so that a backlight can form a left image and a right image via the plurality of sub-pixels after passing through an optical grating. The signal compensating apparatus includes an input unit for receiving a plurality of image input signals sequentially, a compensating unit that compensates the received N-th image input signal based on the received (N+1)th image input signal to produce the N-th image control signal and an output unit for outputting the N-th image control signal to the sub-pixel corresponding to the N-th image input signal.

To achieve the aforesaid objects, the present invention further provides an electronic device that comprises an image display system including a dual view display having a signal compensating apparatus to generate a plurality of image control signals to control a plurality of sub-pixels of the dual view display correspondingly, so that a backlight can form a left image and a right image via the plurality of sub-pixels after passing through an optical grating. The signal compensating apparatus includes an input unit for receiving a plurality of image input signals sequentially, a compensating unit that compensates the received N-th image input signal based on the received (N+1)th image input signal to produce the N-th image control signal, and an output unit for outputting the N-th image control signal to the sub-pixel corresponding to the N-th image input signal; and an input unit coupled with the dual view display to control the display of images by transmitting signals to the dual view display.

The electronic device, the dual view display and the signal compensating method thereof for achieving the objects of the present invention use a signal compensating apparatus that features the signal compensating method to prevent the display quality of the display screen from being affected or avoid cross talk. Moreover, the dual view display and the signal compensating apparatus and method thereof of the present invention do not require upgrading hardware or changing fabrication process change of the display screen, thereby the costs and time required for addressing the cross-talk problem can be reduced.

The objects, features and effects of the present invention are detailed with reference to the accompanying drawings. It should be understood that the accompanying drawings and embodiments are provided so that this disclosure will fully convey the scope of the invention, and this invention should not be construed as limited to the embodiments set forth herein.

### BRIEF DESCRIPTION OF THE DRAWINGS

FIG. 1 shows the system configuration of a dual view display according to an embodiment of the present invention.

FIG. 2 shows the system configuration of a signal compensating apparatus according to an embodiment of the present invention.

FIG. 3 shows the signal mapping table of a compensating unit according to an embodiment of the present invention.

FIG. 4 shows the display configuration of a conventional dual view display.

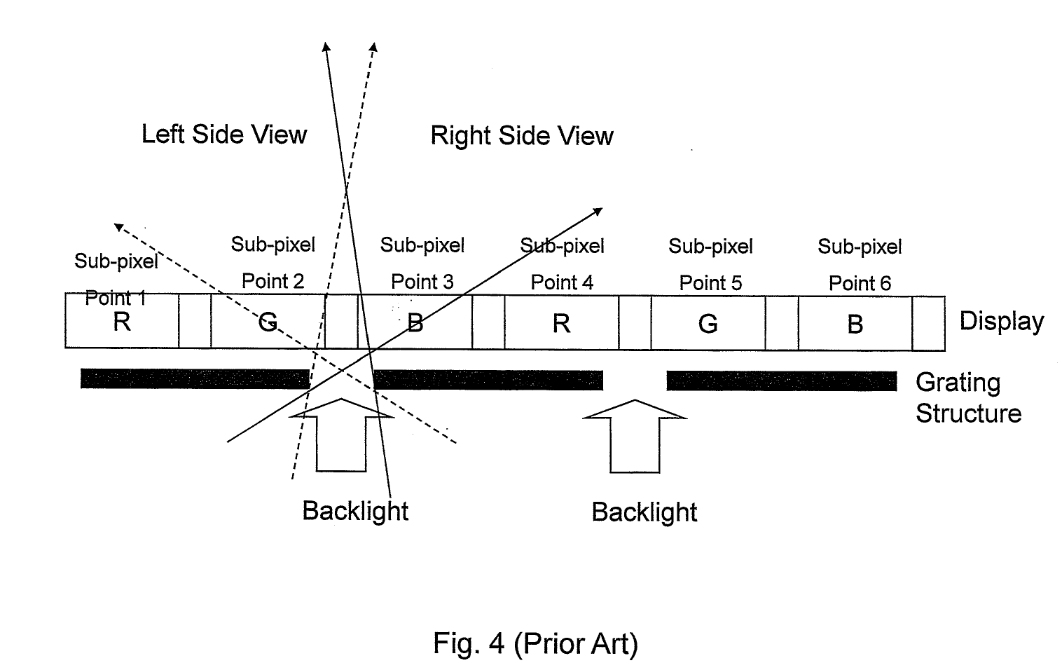

FIG. 5 shows the configuration of an image display system comprising the dual view display according to an embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The present invention provides a dual view display and the signal compensating apparatus and method thereof. The signal compensating apparatus can compensate the image input signal of the sub-pixel, so as to prevent the subsequently inputted image signal from affecting the brightness of the sub-pixel corresponding to the previously inputted image signal or to avoid the cross-talk effect.

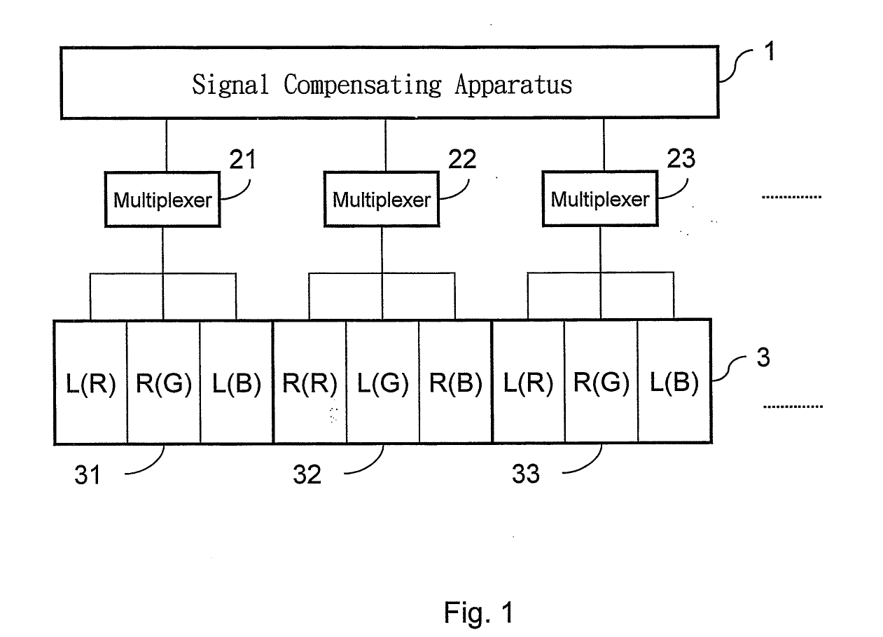

Referring to FIG. 1 which shows the system configuration of a dual view display according to an embodiment of the present invention. The dual view display comprises a signal compensating apparatus 1 for receiving a plurality of image input signals and generating correspondingly a plurality of image control signals, and then the image control signals will be transmitted to a plurality of pixels 31, 32, 33 of a display screen 3 via a plurality of multiplexers 21, 22, 23 to control the brightness of the sub-pixels of the plurality of pixels 31, 32, 33.

In an embodiment of the present invention, the sub-pixels are arranged according to the alternating arrangement of three primary colors R, G, B (R-G-B, R-B-G, G-R-B, G-B-R, B-R-G, or B-G-R) as well as the alternating arrangement of the left and right display (L-R or R-L). In an embodiment of the present invention, the sub-pixels are arranged according to the following arrangement: L(R), R(G), L(B), R(R), L(G), R(B), L(R), R(G), L(B), etc. The value of the sub-pixel outside the parentheses represents the left or right signal, where L represents that the sub-pixel signal is a left signal for generating a left image while R represents that the sub-pixel signal is a right signal for generating a right image. The value of the sub-pixel in the parentheses represents the color of the sub-pixel, where (R) denotes red, (G) denotes green, and (B) denotes blue.

In a dual view display system, the display effect of each sub-pixel will be affected by the voltage of the next sub-pixel. Thus after the image control signal of the next sub-pixel is inputted and enables the corresponding sub-pixel to produce a voltage variation, the brightness of the previously inputted sub-pixel will decay or increase correspondingly. In an embodiment of the present invention, the dual view display exploits a signal compensating apparatus 1 to receive the image input signals of sub-pixels L(R), R(G), L(B), R(R), L(G), R(B), L(R), R(G), L(B), etc. sequentially, compensate each image input signal based on the value of the next image input signal, convert the compensated image input signal into an image control signal and output the image control signal to the corresponding sub-pixel.

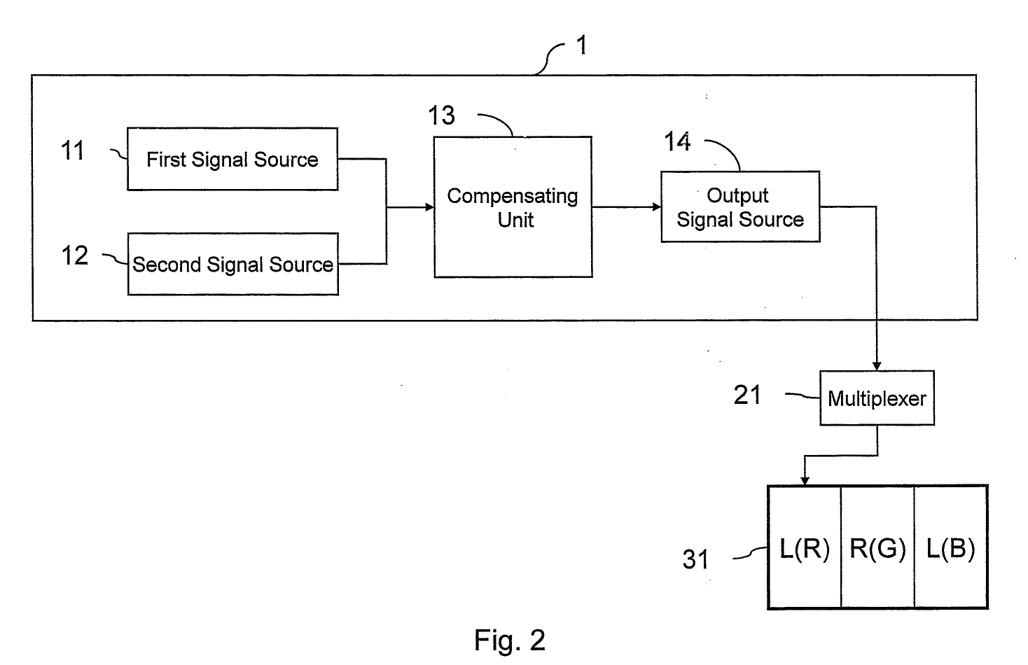

Referring to FIG. 2 that shows the system configuration of a signal compensating apparatus 1 according to an embodiment of the invention. The signal compensating apparatus 1 comprises a compensating unit 13 that compensates one of the received plurality of image input signals based on the received plurality of image input signals to generate a compensated image control signal, and then output the image control signal to control the brightness of a sub-pixel. In an embodiment of the present invention, such image input signals and image control signals have grayscale values ranging from 0 to 255 to denote the intensity of brightness.

In an embodiment of the present invention, the compensating unit 13 is connected to a first signal source 11 and a second signal source 12 to receive two sequentially inputted image input signals in each operation, wherein the first signal source 11 receives the N-th image input signal in a single operation and the second signal source 12 receives the subsequently inputted (N+1)th image input signal at the same operation. The compensating unit 13 is further connected with an output signal source 14 to output an image control signal in each operation. When the compensating unit 13 receives the N-th image input signal and the (N+1)th image input signal, it will compensate the N-th image input signal based on the (N+1)th image input signal, and then the output signal source 14 will output a N-th image control signal to the sub-pixel corresponding to the N-th image input signal to control its brightness.

In an embodiment of the present invention, when the first signal source 11 receives the image input signal corresponding to sub-pixel L(R) of pixel 31 and the second signal source 12 receives the image input signal corresponding to sub-pixel R(G) of pixel 31, the output signal source 14, following the operation of the compensating unit 13, will output a compensated image control signal to sub-pixel L(R) of pixel 31.

According to the features of a dual view display, after the subsequently inputted image input signal enables its corresponding sub-pixel, the voltage of this sub-pixel will affect the brightness of the sub-pixel corresponding to the previously inputted image input signal. Thus in an embodiment of the present invention, the compensating unit 13 will, in each operation, compensate the N-th image input signal received by the first signal source 11 based on the (N+1)th image input signal received by the second signal source 12 to compensate the brightness change of the sub-pixel corresponding to the N-th image input signal caused after the (N+1)th image input signal enabled its corresponding sub-pixel. The compensating unit 13 also produces an N-th image control signal corresponding to the compensated N-th image input signal of the first signal source 11 based on the compensated Nth image input signal of the first signal source 11, and then the output signal source 14 will send the N-th image control signal to the display screen 3 to control the brightness of the sub-pixel corresponding to the N-th image input signal received by the first signal source 11.

In the aforesaid embodiment, the compensating unit 13 operates in a manner where the (N+1)th image input signal originally inputted into the second signal source 12 will be inputted into the first source signal 11 and a subsequently inputted (N+2)th image input signal will be inputted into the second signal source 12 in the next operation. Thus in the aforesaid embodiment, after the compensating unit 13 of the signal compensating apparatus 1 receives the N-th and (N+1)th image input signals, an N-th image control signal corresponding to the N-th image input signal will be generated, and a (N+1)th image control signal will be generated after the compensating unit 13 receives the (N+2)th image input signal.

In an embodiment of the present invention, the compensating unit 13 uses a signal mapping table to record the effects of the image input signal of a second sub-pixels to the first sub-pixel between two adjacent sub-pixels, that is, to record the brightness change of all N-th sub-pixels corresponding to different N-th image input signals caused by different (N+1)th image input signals under the same hardware parameters.

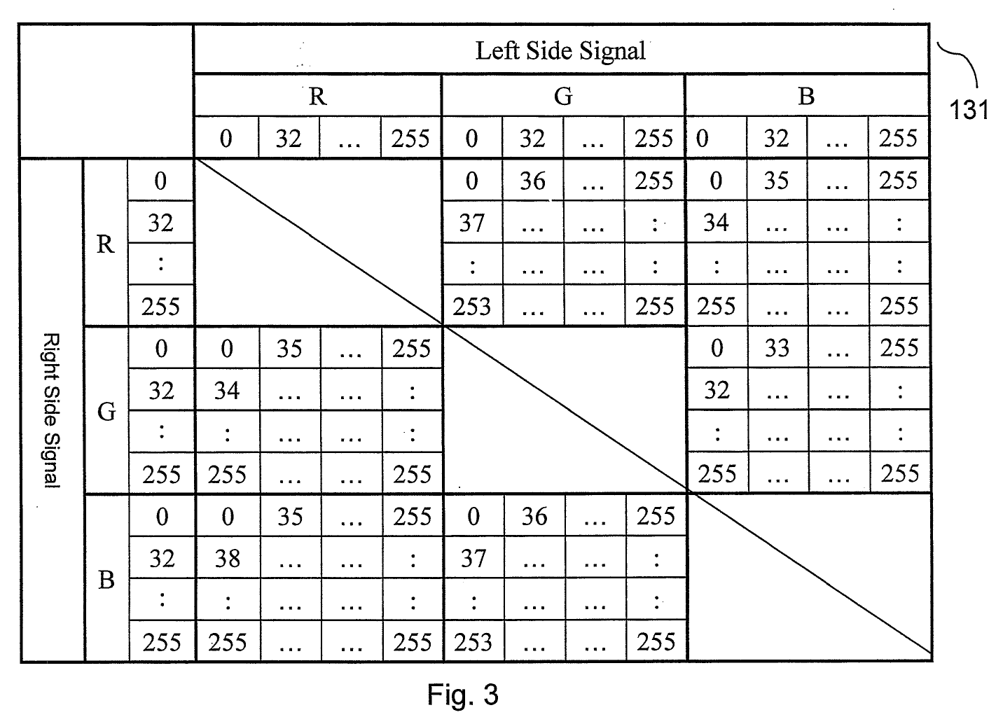

Referring to FIG. 3 that shows the signal mapping table 131 of the compensating unit 13 according to an embodiment of the present invention. The compensating unit 13 includes a signal mapping table 131 for recording the compensated N-th image control signal which is generated as the N-th image input signal requires compensation after the (N+1)th image input signal was subsequently inputted. The image input signals recorded in the signal mapping table 131 can be sorted into left signals, such as the image input signals corresponding to sub-pixels L(R), L(G), and L(B), and right signals, such as image input signals corresponding to sub-pixels R(R), R(G), and R(B). The left and right image input signals and the compensated image control signals have grayscale values ranging from 0 to 255 to denote the intensity of brightness.

In the aforesaid embodiment, the compensating unit 13 uses the table look-up method to learn the actual image control signal required by the sub-pixel corresponding to the N-th image input signal based on the grayscale values contained in the N-th image input signal and the (N+1)th image input signal received by the first signal source 11 and the second signal source 12 respectively. The compensating unit 13 then produces a compensated N-th image control signal to be outputted to the N-th sub-pixel corresponding to the N-th image input signal via the output signal source 14.

As shown in FIG. 3, if the first signal source 11 receives a left signal corresponding to sub-pixel L(R) which has a grayscale value of 32 and the second signal source 12 receives a right signal corresponding to sub-pixel R(G) which has a grayscale value of 0 in an operation of the compensating unit 13, the compensating unit 13 can learn from the table that the grayscale value of sub-pixel L(R) needs to be compensated to 35. Consequently, the compensating unit 13 will output an image control signal that has a grayscale value of 35 to sub-pixel L(R).

To sum up, the dual view display and the signal compensating method thereof of the present invention utilizes a signal compensating apparatus to compensate the image input signal, which would have been inputted into the display screen without compensation, to produce an image control signal, and then the image control signal will be sent to the display screen to prevent the display quality of the display screen from being affected and avoid the cross-talk effect. As the dual view display and signal compensating method thereof of the present invention carries out the signal compensation task via a preprocessing procedure, the display screen does not require any hardware upgrade or process change. Therefore, the costs and time required for addressing the cross-talk problem can be reduced.

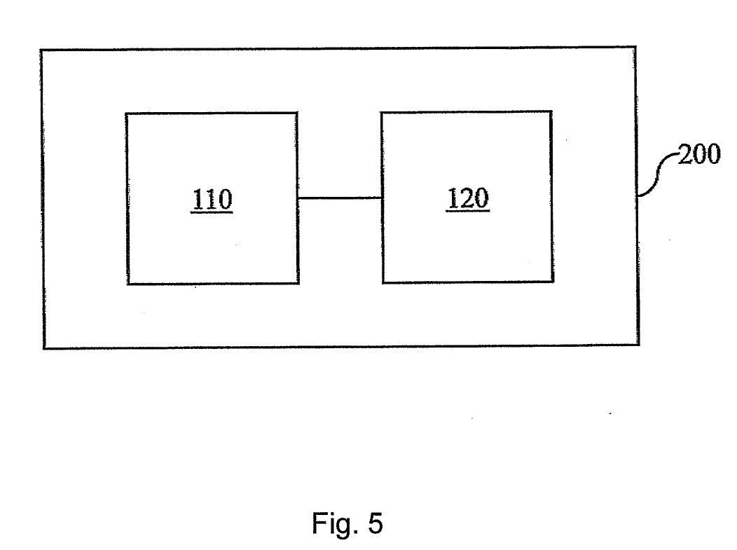

The dual view display of the present invention can be installed in any electronic device that comes with an image display system. FIG. 5 is an arrangement drawing of an image display system 200 comprising the dual view display disclosed in the present invention. Generally, the image display system 200 includes a dual view display 110 and an input unit 120 coupled with the dual view display 110. The input unit 120 transmits signals to the dual view display 110 so that images can be displayed on the dual view display 110. The image display system 200 is, for example, a mobile phone, digital camera, PDA, laptop computer, desktop computer, television, automotive display, digital photo frame, or portable DVD player.

While this invention has been described by way of examples and in terms of preferred embodiments, it is to be understood that this invention is not limited hereto, and that various changes, substitutions, and alterations can be made herein without departing from the spirit and scope of this invention as defined by the appended claims.

What is claimed is:

1. A signal compensating apparatus for generating a plurality of image control signals to control a plurality of sub-pixels of a display correspondingly, so that a backlight can form a left image and a right image via said plurality of sub-pixels after passing through an optical grating, comprising:
an input unit for receiving a plurality of image input signals sequentially;
a compensating unit which compensates said received N-th image input signal based on said received (N+1)th image input signal to produce said N-th image control signal, wherein N is an integer; and
an output unit for outputting said N-th image control signal to said sub-pixel corresponding to said N-th image input signal.

2. The image signal compensating apparatus according to claim 1, wherein said image input signals and said image control signals have grayscale values ranging from 0 to 255.

3. The image signal compensating apparatus according to claim 1, wherein said image input signal or said image control signal is a left signal for displaying said left image or a right signal for displaying said right image, and when said N-th image input signal or said N-th image control signal is a left signal, said (N+1)th image input signal or said (N+1)th image control signal is a right signal.

4. The image signal compensating apparatus according to claim 1, wherein said image input signals and said image control signals are R, G or B signals.

5. The image signal compensating apparatus according to claim 1, wherein said compensating unit contains a mapping table to record the combinations of all N-th image input signals and (N+1)th image input signals, and the corresponding compensated Nth image control signals.

6. A signal compensating method for generating a plurality of image control signals to control a plurality of sub-pixels of a display correspondingly so that a backlight can form a left image and a right image via said plurality of sub-pixels after passing through an optical grating, comprising the steps of:
receiving a plurality of image input signals;
compensating said received N-th image input signal based on said received (N+1)th image input signal to produce said N-th image control signal; and
outputting said N-th image control signal to said sub-pixel corresponding to said N-th image input signal.

7. The image signal compensating method according to claim 6, wherein said image input signals and said image control signals have grayscale values ranging from 0 to 255.

8. The image signal compensating method according to claim 6, wherein said image input signal or said image control signal is a left signal for displaying said left image, or a right signal for displaying said right image, and when said N-th image input signal or said N-th image control signal is a left signal, said (N+1)th image input signal or said (N+1)th image control signal is a right signal.

9. The image signal compensating method according to claim 6, wherein said image input signals and said image control signals are R, G or B signals.

10. The image signal compensating method according to claim 6, wherein said compensating unit further includes a mapping table to record the combinations of all N-th image input signals and (N+1)th image input signals, and the corresponding compensated N-th image control signals.

11. A dual view display having a signal compensating apparatus for generating a plurality of image control signals to control a plurality of sub-pixels of said dual view display correspondingly, so that a backlight can form a left image and a right image via said plurality of sub-pixels after passing through an optical grating, wherein said signal compensating apparatus comprises:
an input unit for receiving a plurality of image input signals sequentially;
a compensating unit which compensates said received N-th image input signal based on said received (N+1)th image input signal to produce said N-th image control signal; and
an output unit for outputting said N-th image control signal to said sub-pixel corresponding to said N-th image input signal.

12. The dual view display according to claim 11, wherein said image input signals and said image control signals have grayscale values ranging from 0 to 255.

13. The dual view display according to claim 11, wherein said image input signal or said image control signal is a left signal for displaying said left image, or a right signal for displaying said right image, and when said N-th image input signal or said N-th image control signal is a left signal, said (N+1)th image input signal or said (N+1)th image control signal is a right signal.

14. The dual view display according to claim 11, wherein said image input signals and said image control signals are R, G or B signals.

15. The dual view display according to claim 11, wherein said compensating unit further includes a mapping table to record the combinations of all N-th image input signals and (N+1)th image input signals, and the corresponding compensated Nth image control signals.

16. An electronic device comprising an image display system which comprises:
a dual view display as described in claim 11; and
an input unit which is coupled with said dual view display so that signals can be transmitted to said dual view display by said input unit to control said display of images on said dual view display.

17. The electronic device according to claim 16, wherein said electronic device is a mobile phone, digital camera, personal digital assistant (PDA), laptop computer, desktop computer, television, automotive display, aerial display, global positioning system (GPS), or portable DVD player.
